(19) United States
(12) Patent Application Publication
(10) Pub. No.: US 2014/0299727 A1
(43) Pub. Date: Oct. 9, 2014

(54) HOLDER FOR A PET TOY

(71) Applicant: Allan Wendling, New Lothrop, MI (US)

(72) Inventor: Allan Wendling, New Lothrop, MI (US)

(21) Appl. No.: 14/312,078

(22) Filed: Jun. 23, 2014

Related U.S. Application Data
(62) Division of application No. 13/692,165, filed on Dec. 3, 2012.
Application No. 13/692,165 is a continuation-in-part of application No. 13/454,374, filed on Apr. 24, 2012, now abandoned.

(51) Int. Cl. A01K 15/02

(52) U.S. Cl. CPC A01K 15/025
USPC 248/176.1

(57) ABSTRACT

A holder for a pet toy having a base with a top. A support extends upwardly from the top of the base and includes an upper support surface having a notch. With a pet toy positioned in the notch, a strap extends over the pet toy and through a slot in the support and is detachably secured to the bottom of the base.

### CROSS-REFERENCE TO RELATED APPLICATIONS

This application is a continuation-in-part of U.S. patent application Ser. No. 13/692,165 filed Dec. 3, 2012, and entitled “Holder for a Pet Toy”, which was a continuation-in-part of U.S. patent application Ser. No. 13/454,374 filed Apr. 24, 2012, and entitled “Holder for a Pet Toy”.

### BACKGROUND OF THE INVENTION

I. Field of the Invention

The present invention relates generally to a holder for a pet toy.

II. Description of Related Art

Many people own pets that are kept inside the house. Some pets, and in particular dogs, instinctively chew objects found within the household. In order to accommodate this instinctive chewing, and also to protect other items within the household, many pet owners provide the dog with a chew bone or other chew toy.

One problem with chew toys for pets, however, is that the pet will drag the chew toy around the house, oftentimes losing it. Similarly, the pet may leave the chew toy in places around the house where the chew toy is unwanted.

### SUMMARY OF THE PRESENT INVENTION

The present invention provides a holder for a pet toy which overcomes the above mentioned disadvantages of the prior art.

In brief, the present invention provides a holder for a pet toy having a generally planar base. A support either is attached to or forms a part of the base and extends upwardly from the top of the base. That support, in turn, includes an upper surface having a central notch which is designed to receive and support a portion of the pet chew toy.

With a portion of the pet chew toy positioned within the support notch, an elongated strap extends over and around the top of the chew toy, through a slot in the base, and is secured to the bottom of the base. Any conventional mechanism, such as a loop-and-pile fastener, may be used to attach the strap to the bottom of the base.

Consequently, with the strap detachably secured to the bottom of the base and extending over and around the pet toy, the pet toy is firmly, but detachably, attached to the base. This permits the pet to chew on the bone as desired without removing the pet toy from the base. Furthermore, when required, the chew toy may be simply and quickly removed from the holder and replaced with a fresh pet toy.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a preferred embodiment of the present invention;

FIG. 2 is a fragmentary sectional view illustrating the holder for the pet toy; and

FIG. 3 is a cross-sectional view taken along line 3-3 in FIG. 1.

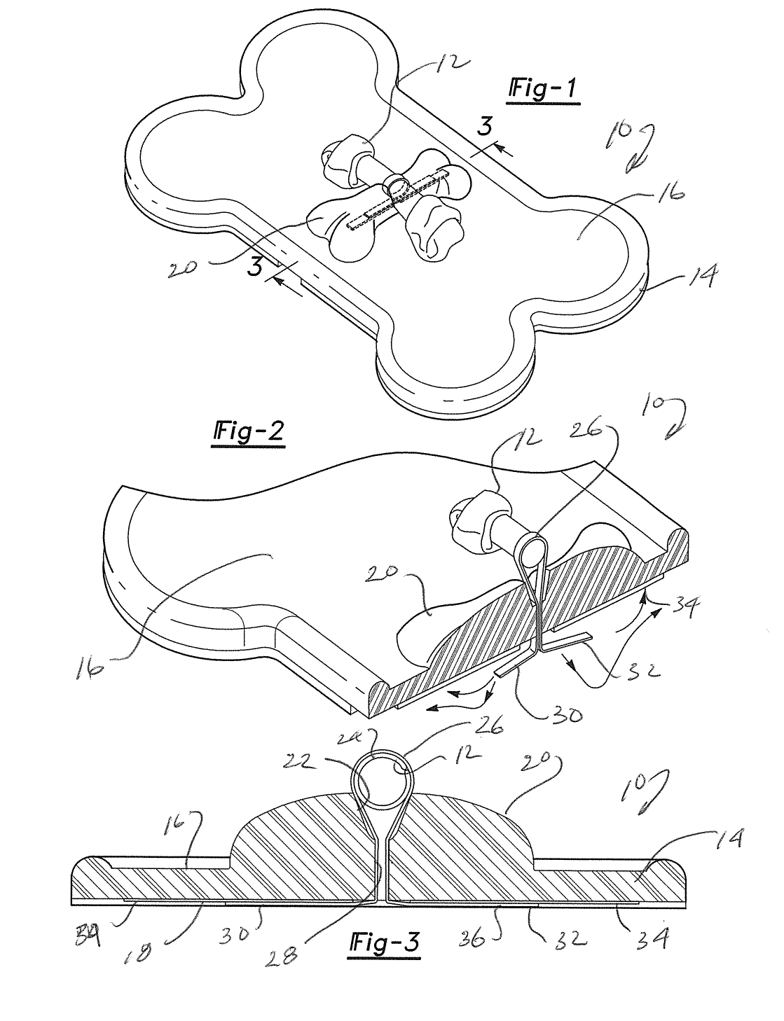

### DETAILED DESCRIPTION OF A PREFERRED EMBODIMENT OF THE INVENTION

With reference to the drawing, a preferred embodiment of a holder 10 for a pet toy 12 is shown. The holder 10 includes a base 14 having a generally planar top 16 and a generally planar bottom 18. The base 14, furthermore, may be made of any suitable material, but preferably is made of a synthetic polymeric material for an inexpensive construction and easy cleaning.

As best shown in FIGS. 2 and 3, a support 20 extends upwardly from the top 16 of the base 14 near the middle of the base 14. The support 20, furthermore, may be either of a one-piece construction with the base 14, as shown, or, alternatively, separately constructed and attached to the base 14.

A notch 22 is formed in the top of the support 20. This notch 22, furthermore, is dimensioned to at least partially receive a portion 24 of the pet toy 12.

In order to secure the pet toy 12 to the support 20, an elongated strap 26 extends around the portion 24 of the pet toy 12 positioned in the notch 22. This strap 26 then extends down through a slot 28 formed through the support 20 and/or base 14. The two ends 30 and 32 of the strap 26 are then detachably secured to the bottom 18 of the base 20 thus detachably securing the pet toy 12 to the holder 10.

Any conventional means may be used to detachably secure the ends 30 and 32 of the strap 26 to the bottom 18 of the base 14. However, as shown in the drawing, one half of a loop-and-pile fastener 34 is fixedly secured to the bottom 18 of the base 14. The other half of the loop-and-pile fastener 36 is then secured to the strap 26 adjacent each end 30 and 32 of the strap 26. In this fashion, the ends 30 and 32 of the strap 26 are detachably secured to the bottom 18 of the base 14 by simply pressing the ends 30 and 32 of the strap 26 against the loop-and-pile fastener 34.

From the foregoing, it can be seen that the present invention provides a simple, yet effective, pet toy holder for securing a pet toy to the holder. Having described my invention, however, many modifications thereto will become apparent to those skilled in the art to which it pertains without deviation from the spirit of the invention as defined by the scope of the appended claims.

I claim:

1. A holder for a pet toy comprising:
a base having a top,
a support secured to and extending upwardly from said top of said base, said support having an upper support surface and a notch formed in said upper surface,
a passageway extending through said support from said notch to a bottom of said base,
with a pet toy positioned in said notch, an elongated strap extending through said passageway in said support and over the pet toy, at least one end of said strap detachably secured to said bottom of said base to thereby secure the pet toy to said support.

2. The holder for a pet toy as defined in claim 1 wherein said at least one end of said strap is attached to said bottom of said base by a loop-and-pile fastener.

3. The holder for a pet toy as defined in claim 2 wherein both ends of said strap are attached to said bottom of said base by loop-and-pile fasteners.
